(19) United States
(12) Patent Application Publication
(10) Pub. No.: US 2008/0270737 A1
(43) Pub. Date: Oct. 30, 2008

(54) Data Processing System And Method

(75) Inventors: Mohan Parthasarathy, Bangalore Karnataka (IN); Kishore Kumar Muppirala, Bangalore Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 12/109,236

(22) Filed: Apr. 24, 2008

(30) Foreign Application Priority Data
Apr. 26, 2007 (IN) 890/CHE/2007

(51) Int. Cl. G06F 12/00

(52) U.S. Cl. 711/203; 711/E12.001

(57) ABSTRACT

Embodiments provide a data processing system comprising at least one hard partition comprising a plurality of virtual partitions; each of the virtual partitions comprising respective virtual address spaces accessible via a memory access means for relating virtual addresses to real addresses of a real memory; wherein each virtual address space comprises respective unique virtual addresses.

### RELATED APPLICATIONS

This patent application claims priority to Indian patent application serial no. 890/CHE/2007, having title “DATA PROCESSING SYSTEM AND METHOD”, filed on 26 Apr. 2007 in India, commonly assigned herewith, and hereby incorporated by reference.

### BACKGROUND TO THE INVENTION

Virtual partitions allow a system administrator to create independent operating environments. Virtual partitions within a server environment are realised using software partitioning technology that enables multiple virtual servers or partitions within a single server or within a hardware partition within a single server to be realised. For example, HP-UX 11i Virtual Partitions (vPars) provides virtual partitions within a single server or, in conjunction with nPartition, within one or more hardware partitions. Each virtual partition hosts an instance of a respective operating system and has associated supporting resources. Optionally, each virtual partition comprises one or more applications and one or more users.

The physical memory of a server configured to have multiple virtual partitions is managed in such a manner that the operating system of each virtual partition appears to have access to the full virtual memory address space. Virtual memory is well known within the art and CPU hardware assists in its realization by implementing a translation look aside buffer (TLB) that caches mappings between virtual addresses used within the virtual partitions to real addresses of memory of the server or other computer system supporting virtual addresses.

Various events occur within computer systems that have global consequences and global effects. For example, a TLB purge operation associated with a given virtual address will remove from the TLB all instances of the virtual address to be purged. While this may be acceptable to the operating system that instigated the TLB purge, within a system having a TLB that is shared among a number of operating systems handling the virtual partitions, the TLB purge operation will remove all instances of the purged virtual address, including those TLB entries having the same virtual address that are associated with partitions other than the partition containing the operating system that instigated the purge. Such global operations can cause serious problems such as operating system panics and degraded system performance.

### BRIEF DESCRIPTION OF THE DRAWINGS

Embodiments of the present invention will now be described, by way of example only, with reference to the accompanying drawings in which:

FIG. 1 shows a prior art partitioned system having a common translation look aside buffer; and

FIG. 2 shows a partitioned system according to an embodiment of the present invention.

### DETAILED DESCRIPTION

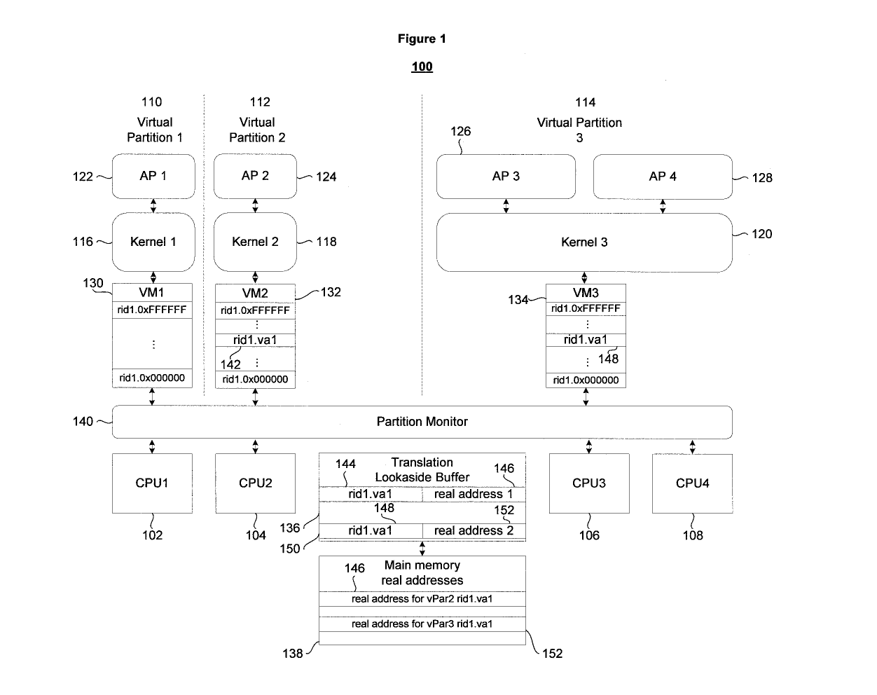

Referring to FIG. 1, there is shown a partitioned computer system 100 comprising four central processing units 102 to 108. The central processing units 102 to 108 are arranged to support a number of virtual partitions 110 to 114. The virtual partitions 110 to 114 comprise respective kernels 116 to 120. The kernels support one or more applications such as, for example, the four applications 122 to 128 illustrated. Each kernel 116 to 120 has access to the whole of a respective virtual address space 130 to 134. A global virtual address on, for example, the Itanium architecture comprises of a region id and a virtual address. Therefore, a global virtual address has the form <region id>.<virtual address>. It can be appreciated that the virtual address spaces, therefore, comprise virtual addresses 0x000000 to 0xFFFFFF in combination with region ids 0x000000 to 0xFFFFFF. The virtual address spaces 130 to 134 are realised using a combination of a translation look aside buffer 136 and a real memory 138. A single TLB 136 is shown in FIG. 1 to simplify explanation and to avoid an overly complicated diagram. It should be noted, however, that each of the CPUs 102 to 108 implement respective TLBs.

The computer system 100 also comprises a partition monitor 140 for establishing the three virtual partitions 110 to 114 by appropriately assigning the CPUs 102 to 108 and other resources of the computer system 100 to the kernels 116 to 120.

It can be appreciated that the virtual memory 132 associated with the second kernel 118 comprises a full virtual address space 0x000000 to 0xFFFFFF, and the full region space of 0x000000 to 0xFFFFFF. The memory 132 is also shown as comprising a particular virtual address 142, having a global virtual address of “rid1.va1”. The TLB 136 comprises a number of entries including an entry 144 that maps the virtual address 142 to a real address 146 within the real memory 138.

Also, it can be appreciated that the virtual memory 134 associated with the third kernel 120 comprises a full virtual address space 0x000000 to 0xFFFFFF, and the full region space of 0x000000 to 0xFFFFFF. The memory 134 is also shown as comprising a particular virtual address 148, having a global virtual address “rid1.va1”. The TLB 136 comprises an entry 150 that maps the virtual address 148 to a real address 152 within the real memory 138.

Assume that a TLB purge operation associated with the virtual address “rid1.va1” of virtual memory 132 associated with the second kernel 118 is generated. The TLB purge operation will remove all instances of the “rid1.va1” from the TLB 136. Therefore, the purge operation will remove the entry associated with the global virtual address “rid1.va1”, that is, virtual address 142, of the memory 132 of the second kernel 118. However, the purge operation will also remove the entry 150 associated with the virtual address “rid1.va1”, that is, virtual address 148, of virtual memory 134 associated with the third kernel 120. Removing entry 150 from the TLB 136 will adversely interfere with the proper operation of the third virtual partition 114.

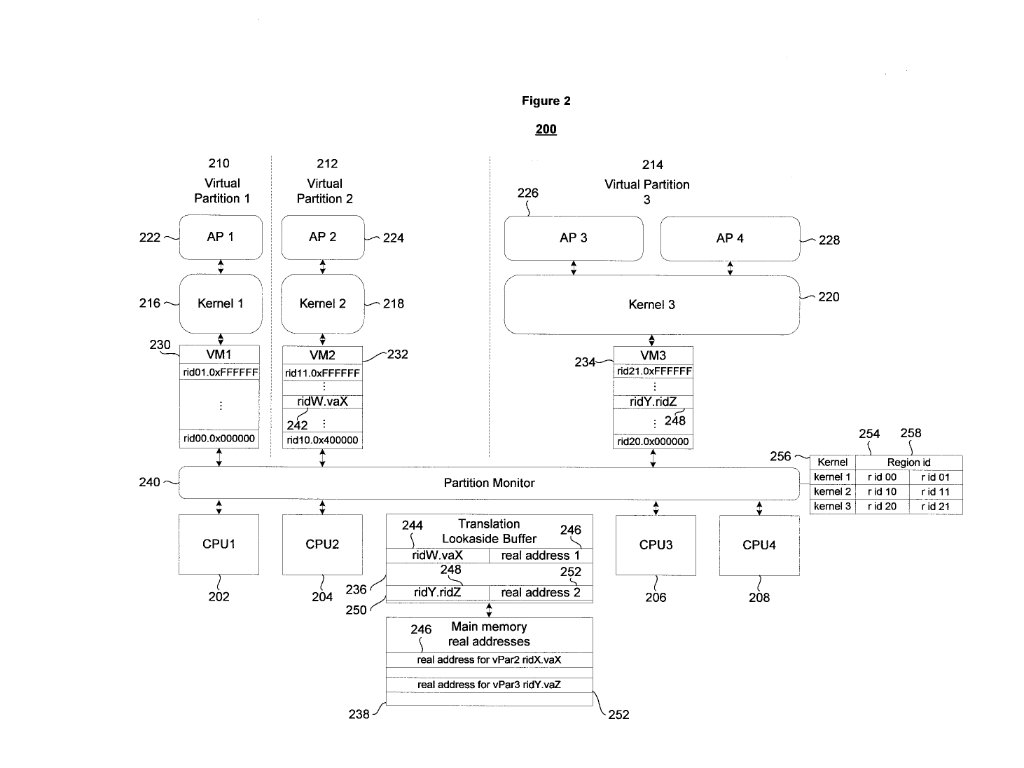

Referring to FIG. 2, there is shown a partitioned computer system 200 comprising four central processing units 202 to 208. The central processing units 202 to 208 are arranged to support a number of virtual partitions 210 to 214. The virtual partitions 210 to 214 comprise respective kernels 216 to 220. The kernels support one or more applications such as, for example, the four applications 222 to 228 illustrated. Each kernel 216 to 220 has access to a respective portion 230 to 234 of the whole of a respective virtual address space. For the purposes of illustration only, assume that the virtual address spaces comprise virtual addresses 0x000000 to 0xFFFFFF and region id space of 0x000000 to 0xFFFFFF inclusive. The respective portions 230 to 234 of the virtual address space are realised using a combination of a translation look aside buffer 236 and a real memory 238. Again, as discussed with reference to FIG. 1 a single TLB 236 is shown in FIG. 2. However, it should be noted that each of the CPUs 202 to 208 implement respective TLBs 236.

The computer system 200 also comprises a partition monitor 240 for establishing the three virtual partitions 210 to 214 by appropriately assigning the CPUs 202 to 208 and other resources of the computer system 200 to the kernels 216 to 220.

It can be appreciated that the virtual memory 232 associated with the second kernel 218 comprises a region id space spanning rid00 to rid01, wherein rid00 represents a first, or lower, region id, and rid01 represents a second, higher region id. For example, the region ids rid00 and rid01 may span 0x400000 to 0x7FFFF of the available region id space of 0x000000 to 0xFFFFFF. The memory 232 is also shown as comprising a particular virtual address 242, having a global virtual address of “ridW.vaX” with ridW falling within the region id space or range defined by rid00 to rid01. In the particular example, ridW falls within the region id space of 0x400000 to 0x7FFFF. The TLB 236 comprises a number of entries including an entry 244 that maps the virtual address 242, ridW.vaX, to a real address 246 within the real memory 238.

Also, it can be appreciated that the virtual memory 234 associated with the third kernel 220 comprises a region id space spanning rid10 to rid11, wherein rid10 represents a first, or lower, region id, and rid11 represents a second, higher region id. For example, the region ids rid10 and rid11 may span 0x800000 to 0xBFFFFF of the full region id space or range 0x000000 to 0xFFFFFF. The memory 234 is also shown as comprising a particular virtual address 248, having a global virtual address of “ridY.vaZ” with ridY falling within the region id space or range defined by rid10 to rid11. In the particular example, ridy falls within the region id space of 0x800000 to 0xBFFFF. The TLB 236 comprises an entry 250 that maps the virtual address 248 to a real address 252 within the real memory 238.

The monitor 240 has access to a table 254 that provides a mapping between kernels 256 and corresponding ranges of region ids 258. For example, one skilled in the art appreciates that a virtual address within, for example, an IA-64 architecture comprises a virtual region number (vrn) also called as region id (RID), a virtual page number (vpn) and an offset. The kernels 216 to 220 are arranged to issue a request to the monitor or CPUs for a range of region ids to be assigned. The monitor 240 determines from the table 254 a contiguous set of available region ids and allocates it to the requesting kernel. The virtual addresses used by the requesting kernel are defined using the set of allocated virtual region numbers. The monitor manages the allocation of the virtual region numbers such that the kernels have different virtual region numbers thereby ensuring that the virtual address spaces allocated to the kernels are different. Therefore, even if, in the above example, “vaX” is identical to “vaY”, the corresponding global addresses, “ridW.vaX” and “ridY.ridZ”, are different and can never be the same due to the monitor, or other entity, controlling allocating of region ids. Therefore, the above mentioned respective portions are defined using a combination of the virtual region number and the virtual page number and the offset. The virtual region number may comprise a predetermined number of bits. For example, the virtual region number may be represented using 3 bits, which would provide up to 8 virtual region numbers that can be divided up among the running partitions.

Assume that a TLB purge operation associated with the global virtual address “ridW.vaX” of virtual memory 232 associated with the second kernel 218 is generated. The TLB purge operation will remove all instances of the “ridW.vaX” from the TLB 236. However, in contrast to the prior art, since the range of region ids available to the second virtual partition 212 does not comprise any region ids that are common to any other virtual partitions and, in particular, to the third virtual partition 214, the TLB purge operation cannot adversely affect entries in the TLB 236 that are associated with the other virtual partitions 210 and 214 even if the virtual addresses “vaX” and “vaZ” are the same. To illustrate further, “ridW” would fall within a region id range rid00 to rid01, and this range does not overlap with the ranges assigned to any other partition. This ensures that the global virtual addresses across partitions are always unique and, hence, that TLB purges on one partition cannot impact others.

Although the above embodiments have been described with reference to a TLB purge operation, which is an embodiment of a global operation, embodiments are not limited thereto. Embodiments can be realised in which the virtual addresses can be affected by any other type of operation, particularly on a global basis, that is, with the potential, but for the invention, to adversely affect global virtual addresses associated with other virtual partitions or CPUs.

The embodiments described above have been illustrated using three partitions 210 to 214. However, some other number of partitions can equally well benefit from the invention. Furthermore, the above embodiments have been illustrated using three kernels 216 to 220. However, some other number of kernels can equally well be used. Still further, the applications 222, 224, 226 and 228 are merely illustrative. Some other number, that is, total number of applications or number of applications per virtual partition could equally well have been used to illustrate the advantages of the embodiments of the invention.

The above embodiments have been illustrated using four CPUs. However, embodiments are not limited to such an arrangement. Embodiments can be realised using any number of hard partitions. In the above embodiment, the first CPU 202 and the second CPU 204 form part of first and second hard partitions whereas the remaining two CPUs 206 and 208 for part of the same hard partition.

As used herein, the following definitions apply

A complex is an entire partitionable computer system, which may comprise, for example, a server, including at least one cabinet, all cells, IO chassis, cables, and power and utility components. The above computer system 200 merely forms part of such a complex.

A hard partition is an isolated hardware environment, such as, for example, an nPartition within a server. The nPartition product is available from Hewlett Packard Company. A single standalone server can be thought of as being equivalent to a hard partition for some embodiments.

An nPartition is a subset of a complex that divides the complex into groups of cell boards where each group operates independently of other groups. For example, an nPartition can run a single instance of an operating system such as, for example, HP-UX or be further divided into virtual partitions.

A virtual partition is a software partition of a hard partition where each virtual partition contains an instance of an operating system such as, for example, HP-UX. Although a hard partition can contain multiple virtual partitions, the inverse is not true. A virtual partition cannot span a hard partition boundary.

It can be appreciated that careful assignment of virtual addresses of the virtual address space such that the virtual addresses of the virtual partitions are mutually exclusive ensures that global operations instigated or issued by one virtual partition cannot adversely affect another virtual partition since there is no overlap between virtual addresses associated with virtual partitions.

The above embodiments have been described with reference to contiguous region id ranges forming a respective portion of the virtual address spaces. For example, the second portion 232 of virtual addresses comprises region ids 0x400000 to 0x07FFFFF. However, embodiments are not limited to such an arrangement. Embodiments can be realised in which the virtual address space associated with the second kernel comprises at least one of non-contiguous and contiguous region ids. Furthermore, the above respective portions have been illustrated using contiguous blocks of region id space. However, alternative embodiments can be realised in which any one or more of the blocks of region ids are not contiguous with any one or more of the other blocks of virtual addresses. For example, rather than having region ids spanning 0x800000 to 0xBFFFFF, the region id space 234 associated with the third kernel 220 may span a range 0xC00000 to 0xFFFFFF or some other value providing there is no overlap with any region ids of the other virtual address spaces 230 and 232.

Additionally, embodiments can be realised in which any of the kernels within the virtual partitions may request additional region id space. In response to a request for additional region id space, the partition monitor, or other entity, may assign further region id space to the existing region id space associated with the requesting kernel. The further region id space may be contiguous or otherwise with the existing region id space associated with the kernel requesting the additional region id space. The additional region id space assigned to the requesting kernel will comprise one or more region ids that are exclusive or unique to the requesting kernel or virtual partition comprising the requesting kernel. This ensures that global operations such as, for example, TLB purge operations do not adversely affect virtual addresses associated with other kernels or virtual partitions.

It will be appreciated that embodiments of the present invention can be realised in the form of hardware, software or a combination or hardware and software. Suitably, embodiments provide computer readable medium storing, containing, communicating, propagating or transporting a program containing instructions arranged to realise a computer system as described with reference to the above embodiments or to implement a method as described with reference to the above embodiments. The computer readable medium may comprise, for example, electronic, magnetic, optical, electromagnetic, infrared, or semiconductor based system, apparatus, device or propagation medium. In particular, specific examples of a computer readable medium may comprises an electrical connection having one or more wires, a portable computer disk or diskette, RAM, ROM, erasable, programmable memory, such as EPROM, EEPROM, or Flash memory, an optical fibre, a CD, a DVD, a computer readable tape. Still further, the computer readable medium may comprise paper or other suitable medium upon which the program can be printed and read via, for example, optical scanning, then compiled or interpreted or otherwise executed before being stored in a memory.

1. A data processing system comprising at least one hard partition comprising a plurality of virtual partitions; each of the virtual partitions comprising respective virtual address spaces accessible via a memory access means for relating virtual addresses to real addresses of a real memory; wherein each virtual address space comprises respective unique virtual addresses.

2. A data processing system as claimed in claim 1 comprising means to assign to a virtual partition of the plurality of virtual partitions a virtual address space comprising respective unique virtual addresses.

3. A data processing system as claimed in claim 2 wherein the means for assigning is responsive to a predetermined operation.

4. A data processing system as claimed in claim 3 wherein the predetermined operation comprises associating a predetermined class of software with at least one virtual partition of the plurality of virtual partitions.

5. A data processing system as claimed in claim 4 wherein the predetermined class of software comprises an operating system.

6. A data processing system as claimed in claim 3 wherein the predetermined operation comprises a boot operation.

7. A data processing system as claimed in claim 1 comprising means for assigning further unique virtual addresses to any of said respective unique virtual addresses.

8. A data processing system as claimed in claim 7 wherein the means for assigning further unique virtual addresses to any of said respective unique virtual addresses is responsive to a request associated with a predetermined class of software for more memory.

9. A complex comprising a data processing system as claimed in claim 1.

10. A data processing method comprising associating a first set of virtual addresses with at least of one a first virtual partition of a computer system or a kernel of such a virtual partition of such a computer system wherein the virtual addresses of the first set of virtual addresses are unique to the least one of the first virtual partition of the computer system or the kernel of the first virtual partition of the computer system such that the first set comprises no virtual addresses in common with at least a second set of virtual address associated with at least one of a second virtual partition of the computer system or a second kernel of the second virtual partition of the computer system.

11. A data processing method as claimed in claim 10 comprising associating a third set of virtual addresses with said at least of one the first virtual partition of the computer system or the kernel of such the first virtual partition of the computer system wherein the virtual addresses of the third set of virtual addresses are unique to the least one of the first virtual partition of the computer system or the kernel of the first virtual partition of the computer system such that the third set comprises no virtual addresses in common with at least said a second set of virtual address associated with at least one of said second virtual partition of the computer system or said second kernel of the second virtual partition of the computer system.

12. Computer readable medium comprising a computer program having instructions arranged to realise a system as claimed in claim 10.
